(19) United States
(12) Patent Application Publication
(10) Pub. No.: US 2023/0392082 A1
(43) Pub. Date: Dec. 7, 2023

(54) PROCESS FOR THE CONTROL OF SOFTENING POINTS OF PETROLEUM HYDROCARBON MATERIALS

(71) Applicant: ADVEN INDUSTRIES INC., Edmonton (CA)

(72) Inventor: Weixing CHEN, Edmonton (CA)

(21) Appl. No.: 18/031,975

(22) PCT Filed: Oct. 15, 2021
(86) PCT No.: PCT/CA2021/000092

§ 371 Date: Apr. 14, 2023

Related U.S. Application Data
(60) Provisional application No. 63/092,912, filed on Oct. 16, 2020.

(51) Int. Cl. C10G 29/28; C01B 32/33; C01B 32/05; C10G 1/08

(52) U.S. Cl. CPC C10G 29/28; C01B 32/33; C10G 2300/206; C10G 1/086; C10G 2300/1077; C01B 32/05

(57) ABSTRACT

The present disclosure relates to a method of treating hydrocarbon materials with thermoplastic nature that are liquid at room temperature or become liquid upon heating, to increase their softening point temperature up to 400° C. The method includes the steps of mixing a sulfur-containing gaseous catalyst with the hydrocarbon material in an environmentally controlled reactor, Heating the mixture to a temperature between 280° C. and 480° C. in a flowing gas environment and holding the mixture at this temperature for a period of time from 2 hours to 5 hours and stirring the mixture and maintaining stirring until the hydrocarbon material becomes solid.

### FIELD

A thermal and chemical process has been developed to increase softening points of petroleum hydrocarbon materials without altering chemical compositions of the original hydrocarbon materials.

### BACKGROUND

Petroleum and petroleum-derived products are complex mixtures of hydrocarbon polymeric materials of different molecular weights.

Petroleum products belonging to the category of thermoplastic polymers, have softening points and melting points related to their molecular mass and to the intramolecular and intermolecular forces within the polymer. Melting points of thermoplastic polymers with a molecular weight in the range of 100 mol/g are well below −50° C., meaning they are always liquid at room temperature, while those with a molecular weight larger than 400 mol/g have higher softening points, typically higher than 50° C.

At very low temperatures, thermoplastic polymers are very brittle. With temperature rise, there is usually a sudden drop of their rigidity. The temperature point at which this happens is termed as the glass point, T_{g}. Between T_{g} and the melting temperature (Tₘ) of the thermoplastic polymer is a rubber-fluid state, called the softening point, where the polymers are softened and could be pulled into filaments such as fibers. These fibers can then be treated to make carbon fibers.

When such petroleum materials are used as precursors for fabricating carbon fibers, their softening points are preferred to be in the range of 230° C. to 280° C. to allow sufficient strength for pulling or spinning into fibers. If the softening point is below this temperature, then the petroleum product is too soft and will tend to liquidize and not be manipulatable. Petroleum products with this range of softening points, commonly petroleum pitch, are first melt-spun to fabricate green fibers. The green fibers are then stabilized or oxidized in a process that is usually performed at about 200-400° C. for several hours in oxygen containing gas to cross-link the molecules to the point where the fibers do not melt or fuse together. This is followed by carbonization, performed at much higher temperatures, typically about 1000-2000° C., in an environment without oxygen.

If a petroleum product has a lower softening point below 230° C., then such material will undesirably result in fusion of green fibers when they are heated to the oxidation/stabilization temperature. Hence, it is desirable to increase the softening points of petroleum and petroleum products.

Use of petroleum products with softening points below 230° C. can also lead to substantially low carbon fiber yields, well below 50% because of the presence of a high fraction of components with low molecular masses that could become volatile, as compared carbon fiber yields from petroleum products with higher softening points, like for example petroleum pitch. A higher softening point may also require shorter stabilization times (for example, Fuller et al U.S. Pat. No. 3,959,448),

On the other hand, it is also known that petroleum pitch-based carbon-fibre precursors with high softening points require a higher melting-spinning temperature. The resulting carbon fibers fabricated at high spinning temperatures usually exhibit lower compression strength at low temperatures (U.S. Pat. No. 5,213,677, 1993, Spinning pitch for carbon fibers and process for its production). Therefore, manipulating and controlling the softening point temperature is very important for carbon fibre production.

There are situations where crude oils or bitumen are preferred to be transferred in their solid forms. An example might be the heavy crude oil or bitumen, such as those produced from Alberta oil sands. By converting heavy bitumen into solids it can be shipped like coal. For this application, an increase of the softening points of these heavy hydrocarbon materials to about 100° C. would be required.

The softening points of petroleum materials are increased commonly by removing the light fraction from the petroleum materials during thermal condensation (>350° C.). When temperature is increased, dehydrogenation, cross-linking, condensation etc. occur, which releases H₂, H₂O, H₂S and low molecular weight components. At the same time, the remaining materials will possess higher molecular weight with lower H/C ratio and higher softening point.

The prior art discloses several methods developed for increasing softening points of isotropic pitch (Carbon Fibers, Technology & Engineering, 3rd Edition, J-B Donnet, R. C. Bansal, 1998, page 45). These include reducing pressure thermal condensation, wiped film evaporator, oxygen containing gas blow oxidation, sulphidation, additive method and PVC method. The prior art also discloses many methods, as summarized below, for the purpose of either increasing or reducing softening point and viscosity of mesophase pitch, for the purpose of using them as precursors for fabricating carbon fibers.
Thermal modification: These methods are aimed to remove the light molecular fractions which hinder the formation of mesophase.
Solvent modification: Using solvents, the lowest molecular weight material remained in solution, while higher molecular weight materials precipitate and are extracted for carbon fiber melt-spinning.
Hydrogenation: Mesophase pitch turns into partly hydrogenated fused ring aromatic hydrocarbon, which can result in the formation of pitch with higher molecular weight, lower melt temperature and lower viscosity.
Catalyst modification: Lewis acids (e.g., AlCl₃, HF/BF₃) are added to achieve catalytic polymerization that could increase softening point and viscosity of mesophase

One of the major barriers hindering widespread use of carbon fibers is the cost of the preparation of the feedstocks from which the fibers are produced. Most processes commonly require heating of a conventional pitch material at elevated temperatures over a period of several hours (For example, in Lewis et al U.S. Pat. No. 3,967,729, Singer U.S. Pat. No. 4,005,183, and Schulz U.S. Pat. No. 4,014,725), or post-processing filtration to remove additives and solids from reaction.

### SUMMARY

The present disclosure relates to a method of treating hydrocarbon materials with thermoplastic nature that are liquid at room temperature or become liquid upon heating, to increase their softening point temperature up to 400° C. The method includes the steps of:
a. mixing a sulfur-containing gaseous catalyst with the hydrocarbon material in an environmentally controlled reactor;
b. heating the mixture to a temperature between 280° C. and 480° C. in a flowing gas environment and holding the mixture at this temperature for a period of time from 2 hours to 5 hours; and
c. stirring the mixture and maintaining stirring until the hydrocarbon material becomes solid.

The final softening point of the hydrocarbon material can be controlled through an adjustment of the amounts of catalyst, the treatment temperature and time and the type of gas environments being used during the method.

### DETAILED DESCRIPTION

The description of the present disclosure has been presented for purposes of illustration and description, but it is not intended to be exhaustive or limited to the disclosure in the form disclosed. Many modifications and variations will be apparent to those of ordinary skill in the art without departing from the scope and spirit of the disclosure. Embodiments were chosen and described in order to best explain the principles of the disclosure and the practical application, and to enable others of ordinary skill in the art to understand the disclosure for various embodiments with various modifications as are suited to the particular use contemplated. To the extent that the following description is of a specific embodiment or a particular use of the disclosure, it is intended to be illustrative only, and not limiting of the claimed disclosure.

This disclosure teaches a method of increasing softening points of hydrocarbon materials including petroleum, its heavier fractions after refineries, and other thermoplastic polymeric materials. The product of the method can be used as a precursor for carbon fibers or activated carbon, or to solidify the hydrocarbon material for transport in a solid form.

The method of treatment is relatively short, normally less than 5 hours, and can be performed in either a batch or a continuous setup. A batch process can be achieved by conducting all steps in one reactor, while a continuous setup may require multiple reactors to finish the required steps sequentially. The products of the present method can then serve as precursors to carbon fibres.

The present method involves a thermal and chemical process that avoids altering chemical compositions of the original hydrocarbon materials. The process is relatively short and the resulting materials can be used directly as feed stocks to fabricate carbon fibers or activated carbons with good processability, product yields and performance. This process can also be used to convert hydrocarbon liquids into solids for easy transportation by increasing the softening or melting points of such liquids so that they remain solid at room temperature. The treated hydrocarbon materials having increased softening points are semi-solid or solid materials at room temperature without change of their chemical composition. The semi-solid or solid materials are further processable into solid physical forms including powders and pellets. The pellets are re-heatable to a temperature suitable for extrusion or casting into various shapes and sizes.

The hydrocarbon materials that can be treated in accordance with the present disclosure include coal-derived hydrocarbon material, oilsands bitumen derived hydrocarbons, such as, for example, fluid catalytic cracking (FCC) or residue catalytic cracking (RCC) slurry oil, asphalt, petroleum pitch, vacuum distillation residue or asphaltenes. Asphaltenes are a common component of petroleum and are also thermoplastic polymers. Asphaltenes are the solid precipitates obtained from bitumen or crude oil and are defined operationally as the n-heptane-insoluble, toluene-soluble component of petroleum. Vacuum distillation residue (VDR), also referred to as the bottom-of-the-barrel is also a component of petroleum.

The present methods can be applied to any other hydrocarbon materials that are thermoplastic nature. The method steps are:
a) mixing a catalyst or a solid chemical additive with the hydrocarbon material in an environmentally controlled reactor;
b) heating the hydrocarbon materials or the above mixture to a temperature between 280° C. and 480° C. in a flowing gas environment such as pure nitrogen, pure steam, oxygen containing gas or their mixture, and holding the mixture at this temperature for a time period that can be the entire course of the treatment or can be only for a selected time period of the treatment method;
c) stirring the mixture when the hydrocarbon materials become low viscous and maintaining stirring till the end of the treatment process when the hydrocarbon material becomes a solid,

The mixing step can occur at room temperature before the step of heating, or the mixing step can occur after the hydrocarbon materials are heated in the heating step. Stirring can occur after mixing and heating or stirring can occur during any one or both of mixing and heating. As such, the method can be carried out as three separately timed steps, two separately timed steps or all as one step.

Softening point of hydrocarbon materials can be increased up to 400° C., and more preferably to between 100° C. to 350° C., in the present method by manipulating the following variables:

Catalysts—these serve to in increase the softening point through cross-linking reactions in the hydrocarbon materials, without altering the chemistry of the original hydrocarbon materials. Cross-linking of molecular components, especially those with low molecular mass, form larger molecules with higher softening points.

Catalysts are preferably sulfur-containing catalysts, having for example, a formula of SₓO_{y}. These catalysts can include HSO₄⁻-, HSO₃⁻, S₂O₇²⁻-, S₂O₈²⁻-, S₂O₃²⁻-, SO₃²⁻-containing compounds, These catalysts can decompose and create the desired cross-linking of hydrocarbon materials within a range of temperature from about 250° C. to 500° C. These gas-decomposable catalysts can be added to reactor by bubbling them through the hydrocarbon materials and mixed with the hydrocarbon materials through stirring. A flowrate of gaseous catalyst flowed into the reaction can be varied based on the amount of hydrocarbon material to be treated and also on the flowrate of flowing gas in the gas environment.

Dosage of catalyst is important since when dosing is too high then cross-linking is so severe that the hydrocarbons under treatment could be evolved into thermosetting plastics or cokes. Too low a dosage of catalyst will not produce sufficient cross-linking reactions.

In an alternative embodiment a solid powdered chemical additive can be added to the reactor and mixed with the hydrocarbon material. The powdered chemical additives decompose into the gaseous catalysts that are then catalytic to the process of cross-linking. The catalysts can then further decompose into gaseous phases that are removed out of the reactor, with no bonding to the hydrocarbon materials. As a result, the chemistry of the initial hydrocarbon materials is not altered.

The solid chemical additives are preferably ammonium-, sulfur- and oxygen-containing-compounds, The chemical additives can include (NH₄)₂S₂O₈ (Ammonium persulfate), (NH₄)₂S₂O₇ (Ammonium pyrosulphate), (NH₄)₂SO₄ (Ammonium sulfate), (NH₄)₂S₂O₃ (Ammonium thiosulfate), (NH₄)₂SO₃ (Ammonium Sulfite), NH₄HSO₄ (Ammonium hydrogen sulfate), NH₄HSO₃ (Ammonium hydrogen sulfite), (NH4)₂S (Ammonium sulfide) and most preferably the chemical additive is ammonium pyrosulphate (NH₄)₂S₂O₇.

The above species of chemical additives decompose into HSO₄⁻-, HSO₃⁻, S₂O₇²⁻-, S₂O₈²⁻-, S₂O₃²⁻-, SO₃²⁻-containing compounds, SO₂, or S, or their combinations, that serve as the catalysts causing cross-linking and/or vulcanization of hydrocarbon feedstock material.

One of the solid powdered chemical additives that can be added is ammonium pyrosulphate. The thermal decomposition of ammonium pyrosulphate has been determined to follow the reaction below:

3(NH₄)₂S₂O₇=2NH₃+2N₂+6SO₂+9H₂O 1)

Ammonium persulfate can also be used as a solid chemical additive that decomposes to ammonium pyrosulphate of the present invention at 120° C. through Reaction 2).

2(NH₄)₂S₂O₈=2(NH₄)₂S₂O₇+O₂ 2)

Ammonium sulfate could be used as solid chemical additive that decomposes to ammonium pyrosulphate at temperatures above 250° C.:

(NH₄)₂SO₄=NH₄HSO₄+NH₃ 3)

2NH₄HSO₄=(NH₄)₂S₂O₇+H₂O 4)

From reaction 4) the ammonium pyrosulphate would further decompose into the gaseous catalysts in accordance with reaction 1).

Again, dosing of the catalysts or the solid chemical additives is important to avoid overdosing that can cause severe cross-linking, forming of a non-softening material like coke, or forming materials with very high softening points. In such overdosing cases the chemical additives or gaseous catalysts could be entrapped or bonded into the hydrocarbons, leading to the undesirable chemical change of initial hydrocarbon materials being processed.

The dosage of the chemical additives can be any value from 1% to 50% of hydrocarbon materials to be treated, depending on the initial softening point of the hydrocarbon materials to be treated, the treatment temperature, the gaseous environment, the desired increase in softening point and the desired final rheological properties of the treated materials. In the case of adding a gaseous catalyst directly, the amount of gaseous catalyst added can be equivalent to the amount of gas released from decomposition of a solid chemical additive.

Heating—Depolymerization, which leads to elimination of low molecular weight substances through evaporation of volatile phases upon heating. Processing temperature and time can both be manipulated to control the rate of reaction and the processability of the treated hydrocarbon material for potential future melt-spinning and other activated carbon processing. Hydrocarbons can often become carbonized at temperatures above 480° C., and therefore, the treatment must be performed at a temperature below 480° C. to avoid carbonization or coke formation. Furthermore, the treatment temperature must be higher than the thermal decomposition temperature of any chemical additives being added to the reactor, ensure their decomposition into the gaseous catalysts that cause cross-linking. A heating temperature range of 280° C. to 480° C. is preferred in one embodiment.

Gas environments in the reactor—the gas environment can be either pure nitrogen, pure steam, oxygen containing gas, or their combinations. These gasses are present in addition to the gaseous catalyst present from decomposition of the solid chemical additive catalysts being added. The gas environment serves to modify the hydrocarbon material by any one of the following mechanisms: attaching to chains of the hydrocarbon materials and making the chains longer, by cleaving side chains. Chain cleavage results in chain scission, such as the loss of aliphatic side chains, and leads to lower hydrogen to carbon ratios in the hydrocarbon material being treated. This enables a further control of molecular structures of the final hydrocarbon product, that is the carbon fiber precursor, in terms of melting spinnability, spinning temperature and final mechanical properties of resulting carbon fibers. The flowing gas also reduces chances of the hydrocarbon material getting deposited or stuck onto the inner sides of the treatment equipment.

Depending on the properties of hydrocarbon precursor materials required for further processing into carbon fibers, the selection of the type of gas streams, and the residence time can be varied during the treatment. The selection of gas environments will change the effectiveness of the catalysts in achieving cross-linking. A nitrogen gas environment promotes the formation of coke and increase the softening points more effectively than the steam environment. Steam is preferred when hydrocarbon materials have reached a high softening point and have a high risk of coke-formation. The gas environment also affects the alteration of chemical structure of the initial hydrocarbon materials being treated, for example, through chain cleavage to remove certain side chains or molecular groups as indicated previously, and dehydrogenation that causes the removal of hydrogen from hydrocarbon molecules. Dehydrogenation leads to a decrease of H/C ratio, which may be desired for certain subsequent uses of the treated hydrocarbon materials.

Action of stirring—this serves multiple purposes including heat transfer between hydrocarbon materials and the wall of the reactor, which can be externally heated, mixing of gaseous catalysts or chemical additives with hydrocarbon materials, increasing evaporation, and mixing of gas environment with the hydrocarbon materials being treated.

In a further embodiment of the invention, illustrated in detail in Example 6 below, the inventors have surprisingly found that in the case of hydrocarbon materials having asphaltenes content, the increasing of the softening point of those hydrocarbons is also affected by the asphaltene content in the hydrocarbon material and also by the softening point of the asphaltenes component of the hydrocarbon materials.

For this reason, in the case of hydrocarbon materials with asphaltenes, the steps in the present method of heating in a gas environment for a period of time are somewhat altered. More specifically the inventors have manipulated the method to include two or more discrete sub-steps of heating in a gas environment, each of said discrete sub-steps having at least one of a different heating temperature, a different gas environment and/or a different period of time from the other sub-steps. This serves to control 1) the softening points of asphaltene content, 2) the amount of asphaltene content, and hence 3) the softening point overall.

In one example this can include three discrete sub-steps of holding the mixture at the first temperature for a first period of time in a first gas environment; then holding the mixture at a second temperature for a second period of time in a second gas environment, and then holding the mixture at a third temperature for a third period of time in a third gas environment.

With respect to the discrete temperatures for each sub-step, in one example any one of the first temperature, second temperatures or the third temperature can coincide with a temperatures at which decomposition of solid chemical additives take place, or any one or more of the temperatures can be a temperature at which cross-linking or vulcanization reactions of hydrocarbon materials occur, or they can be the temperatures at which reactions between the flowing gases and the hydrocarbon materials take place. It is also possible for all of these events to take place at the same temperature, which can be the second or third temperature of the treatment.

The present method provides the following aspects:

It combines various processes of molecular modification (de-polymerization, cross-linking, cleavage and cracking) into a set of single process conditions in a single treatment, said conditions which can be tailored to meet various requirements of the final products.
Unlike other methods, the chemical additives and gaseous catalysts, after treatment, convert to gaseous phases and are easy to remove from the hydrocarbon materials being treated, making minimum changes to the chemistry of original hydrocarbon materials.
Hydrocarbon materials produced using the process of the present disclosure have less aliphatic hydrogen present than the original hydrocarbon materials. Higher aromaticity is more desirable when using the product as a carbon precursor for making carbon fibers.
The process of the present disclosure can be applied to treat any hydrocarbon materials regardless of their origins. While the examples herein are demonstrated with petroleum derived hydrocarbon materials, the present process can be used for processing other types of hydrocarbons such as those derived from coal, or other processing activities due to their similar thermoplastic nature.

By way of further description of the process of the present disclosure, reference may be made to the following examples. Unless otherwise indicated, all parts and percentages are by weight.

### EXAMPLE 1

A vacuum refinery residue was used as the feedstock hydrocarbon material. This residue material has a chemical composition listed in Table 1 as Sample 0. (NH₄)₂S₂O₇ solid powder in an amount of 600 g was added into 2 kg of vacuum refinery residue. The mixture was placed in a sealed cylindrical reactor and stirred at a rate of 30 RPM (revolutions per minute) as the mixture was heated to different final temperatures and held at the final temperature for 120 minutes. Flow of N₂ gas was maintained during the entire time of heating and cooling of the mixture when the hydrocarbon materials are at liquid state. The resulting materials were analyzed to determine their yields with respect to their initial weight of vacuum refinery residues, chemical compositions, softening points using a differential scanning calorimetry (DSC), and relative aromatic percentage using proton nuclear magnetic resonance (1H NMR). The results obtained are listed in Table 1. The feedstock hydrocarbon material was a viscous liquid at room temperature and its softening point was below room temperature, but not measured. Treatment at 350° C. (Sample 1) resulted in a decrease of carbon, hydrogen content, but an increase of nitrogen, sulfur and oxygen, aromatic fraction, and a jump of softening point from below room temperature to ˜300° C. Treatment at 380° C. has led to minimum change in chemical compositions except for a reduction of hydrogen, but an increase of softening point to only 240° C., which is lower than the softening point of Sample 1, which was treated at lower temperature. When treatment temperature was increased to 450° C. (Sample 3), the residues had turned into coke (non-softening). In all treated conditions, yield of treated materials decreases with increasing treatment temperature.

TABLE 1
Results for Example 1

| | (NH₄)₂S₂O₇ | Temp. | Time | | SP | Yield | Aromatic | Aliphatic | C | H | N | S | O |
|---|---|---|---|---|---|---|---|---|---|---|---|---|---|
| ID | (%) | (° C.) | (Minute) | Gas | (° C.) | % | % | % | % | | | | |
| Sample 0 | 0 | 0 | 0 | N/A | <25 | 100 | 10.5 | 89.50 | 87 | 9.7 | 0.9 | 2.3 | 0.1 |
| Sample 1 | 30% | 350 | 120 | N2 | 300 | 81 | 17.36 | 82.64 | 82.8 | 8.2 | 1.9 | 3.8 | 3.3 |
| Sample 2 | 30% | 380 | 120 | N2 | 240 | 71 | 19.66 | 80.34 | 87.4 | 8.0 | 1.1 | 2.9 | 0.6 |

| | | | | | | | | | | | | |
|---|---|---|---|---|---|---|---|---|---|---|---|---|
| Sample 3 | 30% | 450 | 120 | N2 | Coke | 37.5 | N/A | 89.5 | 5.0 | 1.5 | 3.3 | 0.7 |

### EXAMPLE 2

The same vacuum residues as used in Example 1 were added with a higher amount of (NH₄)₂S₂O₇ solid powder to make Sample 4. The same treatment procedures as done for Sample 2 in Example 1 was applied to Sample 4. Increasing of (NH₄)₂S₂O₇ to 40% from 30% has converted the residues to a non-softening material (coke).

TABLE 2
Results for Example 2

| | (NH₄)₂S₂O₇ | Temp. | Time | | SP | Yield | Aromatic | Aliphatic | C | H | N | S | O |
|---|---|---|---|---|---|---|---|---|---|---|---|---|---|
| ID | (%) | (° C.) | Min. | Gas | ° C. | % | % | % | % | | | | |
| Sample 0 | 0 | 0 | 0 | | | | 10.5 | 89.50 | 87 | 9.7 | 0.9 | 2.3 | 0.1 |
| Sample 2 | 30 | 380 | 120 | N2 | 240 | 71 | 19.66 | 80.34 | 87.4 | 8.0 | 1.1 | 2.9 | 0.6 |
| Sample 4 | 40 | 380 | 120 | N2 | Coke | 67 | 16.74 | 83.26 | 87.7 | 7.71 | 1.0 | 3.1 | 0.4 |

### EXAMPLE 3

The same vacuum residues as used in Example 1 were treated in different environments. Sample 2 from Example 1 and Sample 5 in this example were added the same amount of (NH₄)₂S₂O₇ and treated at the same temperature. Sample 2 was treated in pure nitrogen gas environments for 2 hours, while Sample 5 was treated further in steam by one additional hour. The treatment in steam following the treatment in nitrogen has increased softening point of Sample 5 by 40° C.

TABLE 3
Results for Example 3

| | (NH₄)₂S₂O₇ | T | Time | | SP | Yield | Aromatic | Aliphatic | C | H | N | S | O |
|---|---|---|---|---|---|---|---|---|---|---|---|---|---|
| ID | (%) | (° C.) | Min. | Gas | ° C. | % | % | % | % | | | | |
| Sample 0 | 0 | 0 | 0 | N/A | <25 | | 10.5 | 89.50 | 87 | 9.7 | 0.9 | 2.3 | 0.1 |
| Sample 2 | 30 | 380 | 120 (N2) | N2 | 240 | 71 | 19.66 | 80.34 | 87.4 | 8.0 | 1.1 | 2.9 | 0.6 |
| Sample 5 | 30 | 380 | 120 (N2) + | N2 + | 280 | 72.5 | 19.88 | 80.12 | 87.4 | 7.9 | 1.1 | 2.9 | 0.7 |
| | | | 60 (steam) | Steam | | | | | | | | | |

### EXAMPLE 4

The same vacuum residues as used in Example 1 were treated in different environments. Sample 6 in this example was treated at 400° C. first in N₂ for one hour and then in steam for one hour. Sample 7 in this example was also treated at 400° C., but first in steam for one hour and then in N₂ for one hour. Sample 6 has a softening point at around 182° C., while Sample 7 after treatment was no-softening (coke). In addition, Sample 7 has lower hydrogen content and product yield than Sample 6. It seems that treatment by applying steam first promotes dehydrogenation and chain cleavage.

TABLE 4
Results for Example 4

| | (NH₄)₂S₂O₇ | | Time | | SP | Yield | Aromatic | Aliphatic | C | H | N | S | O |
|---|---|---|---|---|---|---|---|---|---|---|---|---|---|
| ID | (%) | T (° C.) | Min. | Gas | ° C. | % | % | % | % | | | | |
| Sample 0 | 0 | 0 | 0 | N/A | <25 | N/A | 10.5 | 89.50 | 87 | 9.7 | 0.9 | 2.3 | 0.1 |
| Sample 6 | 30 | 400 | 60 (N₂) + 60 | N₂ + | 182 | 70 | 17.97 | 82.03 | 88.3 | 8.2 | 1.0 | 2.8 | −0.3 |
| | | | (steam) | steam | | | | | | | | | |
| Sample 7 | 30 | 400 | 60 | Steam + | Coke | 60 | 15.54 | 84.46 | 88.0 | 7.9 | 11 | 2.8 | 0.2 |
| | | | (Steam) + 60 | N₂ | | | | | | | | | |
| | | | (N2) | | | | | | | | | | |

### EXAMPLE 5

The same vacuum residues as used in Example 1 were treated in two discrete treatment steps, each of them has different discrete temperature and gas environment. Sample 8 in this example was 1^{st} treated at 350° C. in N₂ for two hours and then at 400° C. in steam only for two hours. Sample 9 in this example was also 1^{st} treated at 350° C., but in steam for two hours and then at 400° C. but in N₂ for two hours. Sample 8 has a softening point and product yield higher than that of Sample 9. In addition, the reverse of gas environments, from N₂ to steam in Sample 8, but from Steam to N₂ in Sample 9, has led to a reduction of C in Sample 8 but an increase of C in Sample 9. In both cases, the amount of hydrogen was reduced, despite more reduction of hydrogen found in Sample 9. All these changes have yielded a much lower H/C mole ratio in Sample 9. The 1st treatment in N₂ promotes cross-linking, which produces higher product yield and softening point than in steam, while 1^{st} treatment in steam enhances dehydrogenation and chain cleavage.

TABLE 5
Results for Example 5

| | | 1st treatment | | | 2nd treatment | | | | | | | | | | |
|---|---|---|---|---|---|---|---|---|---|---|---|---|---|---|---|
| | (NH₄)₂S₂O₇ | T | Time | | T | Time | | SP | Yield | C | H | N | S | O | H/C |
| ID | (%) | (° C.) | (hr) | Gas | (° C.) | (hr) | Gas | (° C.) | % | % | | | | | ratio |
| Sample 0 | N/A | | | | | | | <25 | 100 | 87 | 9.7 | 0.9 | 2.3 | 0.1 | 1.34 |
| Sample 8 | 20 | 350 | 2.0 | N₂ | 400 | 2.0 | steam | 250 | 77 | 84.6 | 8 | 1.1 | 3 | 3.3 | 1.13 |
| Sample 9 | 20 | 350 | 2.0 | steam | 400 | 2.0 | N₂ | 220 | 56 | 88.5 | 7.4 | 1.2 | 2.8 | 0.1 | 1.00 |

### EXAMPLE 6

The same vacuum residues as used in Example 1 were treated in two or three discrete treatment steps, each of them has different, discrete temperature, time and gas environment. In this example, (NH₄)₂S₂O₇ solid powder in an amount of 7 wt % or 4 wt % of vacuum refinery residue was added, which was much less than the amounts being added in previous examples. Sample 10 in this example was 1^{st} treated at 330° C. in N₂ for two hours and then at 420° C. in steam for two hours, which yielded a softening point at 180° C. Sample 11 in this example was Sample 10 being further treated at 410° C. for 1 hour in nitrogen, the 3^{rd} step, which increased the softening point by 20° C. When the 3^{rd} treatment time was increased to 3 hours, the softening point (Sample 12) was further increased by 20° C., compared that of Sample 11. Samples 13-15 were added with 4 wt % (NH₄)₂SO₄ solid powder. In 2^{nd} step, these samples were treated at higher temperature and in nitrogen gas, instead of steam. Samples 15 also had higher 1^{st} treatment temperature. This example illustrates that different amounts of C5-insolubles, namely the content of asphaltenes, present in the hydrocarbon materials can vary the softening point of the overall material. The softening points of C5-insolubles/asphaltenes can also be altered through the treatments. The amounts of asphaltenes and their softening points affect the viscosity and the ability of the treated hydrocarbon materials to be extruded into fibers.

TABLE 6
Results for Example 6

| | | | | | | C5- | SP of C5- |
|---|---|---|---|---|---|---|---|
| | (NH₄)₂S₂O₇ | 1st treatment | 2nd treatment | 3rd treatment | SP | Insolubles | Insolubles |
| ID | (%) | T(° C.)/Time(hr)/Gas | T(° C.)/Time(hr)/Gas | T(° C.)/Time(hr)/Gas | (° C.) | (%) | (° C.) |
| Sample 0 | Not applied | | | | <25 | <30 | ~160 |
| Sample 10 | 7 | 330/2/N₂ | 420/2/steam | Not applied | 180 | 72 | 220 |
| Sample 11 | 7 | 330/2/N₂ | 420/2/steam | 410/1/N₂ | 200 | 75 | 230 |
| Sample 12 | 7 | 330/2/N₂ | 420/2/steam | 410/3/N₂ | 220 | 81 | 270 |
| Sample 13 | 4 | 330/2/N₂ | 435/1.5/N₂ | Not applied | 170 | 77 | 240 |
| Sample 14 | 4 | 330/2/N₂ | 435/1.5/N₂ | 400/2/N₂ | 200 | 86 | 260 |
| Sample 15 | 4 | 350/2/N₂ | 435/1.5/N₂ | 400/2/N₂ | 230 | 90 | 260 |

### EXAMPLE 7

In this example, the feed stock used for treatment is the asphaltenes, which are the solid precipitates obtained by adding n-pentane solvent into bitumen or crude oil, a process known as solvent de-asphalting by those skilled in the art. This process can be applied directly to bitumen and crude oils or after some thermal conversion processes or cracking. The asphaltene is solid material at room temperature but will start to soften by heating to a temperature above and become viscous liquid when temperature gets to 190° C. The fact that asphaltenes soften over a wide range of temperatures reflects their complex compositions that are featured with different molecular structure and molecular masses. By adding (NH₄)₂S₂O₇ and following the procedures similar to those in Example 1, the change of softening points of asphaltenes and all other effects as observed from treating refinery residues can occur. However, the dosage of (NH₄)₂S₂O₇ required to achieve the same degree of changes or effects for asphaltenes is much reduced when compared with refinery residues. For example, adding 10% of (NH₄)₂S₂O₇ into asphaltenes has converted asphaltenes into coke at a treatment temperature of 350° C. By contrast, by adding as less as 5% of (NH₄)₂S₂O₇ into asphaltenes could raise the softening point of asphaltenes to 265° C.

TABLE 7
Results for Example 7

| | (NH₄)₂S₂O₇ | Temp. | Time | | SP | Yield | Aromatic | Aliphatic | C | H | N | S | O |
|---|---|---|---|---|---|---|---|---|---|---|---|---|---|
| ID | (%) | ° C. | Min. | Gas | ° C. | % | % | % | % | | | | |
| Sample A0 | 0 | 0 | 0 | N/A | 190 | 100 | 13.1 | 86.90 | 81.5 | 8.5 | 1 | 7.25 | 1.8 |
| Sample A1 | 20 | 380 | 120 | N2 | Coke | 72.5 | 10.5 | 89.50 | 80.6 | 7.14 | 1.45 | 8.4 | 2.4 |
| Sample A2 | 10 | 350 | 120 | N2 | Coke | 82.5 | 15.97 | 84.03 | 79.83 | 7.62 | 1.56 | 8.35 | 2.6 |
| Sample A3 | 5 | 350 | 120 | N2 | 265 | 89.5 | 19.22 | 80.78 | 81.51 | 7.96 | 1.08 | 7.75 | 1.7 |

### EXAMPLE 8

The present process is used as a pre-treatment stage of a further process for the production of activated carbon. The same vacuum residues as used in Example 1 were used in this example. 600 g of (NH₄)₂S₂O₇ solid powder was added into 2 kg of vacuum refinery residue. The mixture was placed in a sealed reactor and stirred as the mixture was heated to 350° C. and held at the temperature for 2 hours. Flow of N₂ gas was maintained during the entire of heating and cooling of the mixture from and to room temperature. Either pure N₂ was maintained or steam was introduced during the holding at 350° C. for 2 hours. The material obtained from the pre-treatment at different conditions was used to perform chemical activation to produce activated carbons. The procedure of chemical activation is detailed in a prior-art (Activated carbon with high surface area and its making method—U.S. Publication No. 2019/0202702). The same condition of chemical activation was applied to the pre-treated vacuum residues. Pre-treatment of the refinery residues mixed with 30% (NH₄)₂S₂O₇ at 350° C. in N₂ led to an increase of yield of activated carbon but without reducing the specific surface area of resulting activated carbons. However, pre-treatment of the refinery residues mixed with 30% (NH₄)₂S₂O₇ at 350° C. in steam caused a reduction of specific surface area of resulting activated carbon but an increase of yield of activated carbon.

TABLE 8
Results for Example 8

| | (NH₄)₂S₂O₇ | | | | Specific surface area | Yield of activated carbon |
|---|---|---|---|---|---|---|
| | (%) | Pre-treatment | Carbonization | Activation | (m²/g) | (% of refinery residues) |
| Sample B0 | 0 | No | 500° C. × 1 h | 800° C. × 1 h | 1682 | 22.1 |
| Sample B1 | 30 | 350° C. × 2 h in N₂ | | | 1680 | 28.45 |
| Sample B2 | 30 | 350° C. × 2 h in steam | | | 1392 | 35 |

### EXAMPLE 9

The present process is used as a pre-treatment stage of a further process for the production of activated carbon. The same vacuum residues as used in Example 1 were used in this example. 600 g of (NH₄)₂S₂O₇ solid powder was added into 2 kg of vacuum refinery residue. The mixture was placed in a sealed reactor and stirred as the mixture was heated to 400° C. and held at the temperature for 2 hours. Flow of N₂ gas was maintained during the entire of heating and cooling of the mixture from and to room temperature. Either pure N₂ was maintained or steam was introduced during the holding at 400° C. for 2 hours. The material obtained from the pre-treatment at different conditions was used for chemical activation to produce activated carbons. The procedure of chemical activation is detailed in a prior-art (Activated carbon with high surface area and its making method—U.S. Publication No. 2019/0202702). The same condition of chemical activation was applied to the pre-treated vacuum residues. As indicated in Table 8, pre-treatment of the refinery residues mixed with 30% (NH₄)₂S₂O₇ at 400° C. in steam led to an increase of specific surface area of activated carbon with a slight reduction of the yield of activated carbon. However, pre-treatment of the refinery residues mixed with 30% (NH₄)₂S₂O₇ at 400° C. in nitrogen caused a substantial reduction of specific surface area of resulting activated carbon but an increase of yield of activated carbon.

TABLE 9
Results for Example 9

| | (NH₄)₂S₂O₇ | | | | Specific surface area | Yield of activated carbon |
|---|---|---|---|---|---|---|
| ID | (%) | Pre-treatment | Carbonization | Activation | (m²/g) | (% of refinery residues) |
| Sample B0 | 0 | No | 500° C. × 1 h | 800° C. × 1 h | 1682 | 22.1 |
| Sample B3 | 30 | 400° C. × 2 h in steam | | | 1956 | 21.1 |
| Sample B4 | 30 | 400° C. × 2 h in N₂ | | | 1128 | 42.5 |

### EXAMPLE 10

The same vacuum residues as used in Example 1 were used in this example. They were treated in the same way as those presented in Examples 1 to 6 to produce treated vacuum residues that have a softening or melting point higher than room temperature. Such treatments should be performed to avoid the conversion of vacuum residues into a non-softening material (coke). With such a treatment condition, viscous liquid of refinery residues will be converted into semi-solid and/or solid materials with or without change of their chemical composition, and can be transported in the same way as solid materials. These semi-solid or solid materials can be further processed into different physical forms such as powders by grinding after they are cooled, and pellets by an extruder when they are still formable during cooling or after they are re-heated, or cast into a mold of any shapes and sizes. The solid form of refinery residues can be further processed to make carbon fibers, activated carbons, or used as fuel powders for combustion.

### EXAMPLE 11

In this example, the feed stock used for treatment was the oil sands bitumen after removal of diluents. Diluents are usually added up to 30% into oil sands bitumen to reduce viscosity for the convenience of pipeline transportation. The removal of diluents was achieved by heating the oil sands bitumen at 150° C. for 2 hours under vacuum condition. The remaining was processed to produce solid bitumen with a softening point at approximately 110° C. Solid bitumen with this softening point can be safely transported in a way like coal. The bitumen after diluents-removal had a softening point less than 20° C. (Sample C0). By adding different amount of (NH₄)₂S₂O₇ and adjusting processing temperature from 330° C. to 350° C., all the samples (Samples C1 to C3) can reach a softening point at around 110° C. However, the yield of solid bitumen products was different, about 89.5% when processing temperature was at 330° C., but was reduced to about 69% when the processing temperature was increased to 350° C.

TABLE 10
Results for Example 11

| | (NH₄)₂S₂O₇ | Temperature | Time | | Yield | SP |
|---|---|---|---|---|---|---|
| ID | (%) | (° C.) | (hr) | Gas | (%) | (° C.) |
| Sample C0 | Not applied | | | | | <20 |
| Sample C1 | 26 | 330 | 2 | N2 | 89.5 | 110 |
| Sample C2 | 22 | 340 | 2 | N2 | 84.4 | 110 |
| Sample C3 | 20 | 350 | 2 | N2 | 69 | 110 |

### EXAMPLE 12

In this example, the same way of preparing for hydrocarbon samples as in Example 11 was used. However, the addition of (NH₄)₂S₂O₇ catalyst was replaced by the addition of (NH₄)₂S₂O₈ (Ammonium persulfate) and (NH₄)₂S₂SO₄ (Ammonium sulfate), respectively. Ammonium persulfate decomposes to (NH₄)₂S₂O₇ and O₂ at 120° C. The same results as shown in Table 10 can be achieved provided that the amount of (NH₄)₂S₂O₈ being added was about 10% higher than the amount of (NH₄)₂S₂O₇ listed in Table 10. By contrast, when (NH₄)₂SO₄ is to be added, its amount must be about 25% higher than the amount of (NH₄)₂S₂O₇ in order to obtain the same results listed in Table 10. (NH₄)₂SO₄ decomposes into (NH₄)₂S₂O₇ as shown in Reactions 3) and 4).

1. A method of treating hydrocarbon materials with thermoplastic nature that are liquid at room temperature or become liquid upon heating, to increase their softening point temperature up to 400° C., said method comprising the steps of:
a. mixing a sulfur-containing gaseous catalyst with the hydrocarbon material in an environmentally controlled reactor;
b. heating the mixture to a temperature between 280° C. and 480° C. in a flowing gas environment and holding the mixture at this temperature for a period of time from 2 hours to 5 hours; and
c. stirring the mixture and maintaining stirring until the hydrocarbon material becomes solid.

2. The method of claim 1, wherein the gas environment is selected from the group consisting of nitrogen, steam, oxygen containing gas and mixtures thereof.

3. The method of claim 1, wherein the gaseous catalyst is a sulfur- and oxygen-containing gaseous catalyst.

4. The method of claim 1, wherein the step of mixing the catalyst comprises:
a. mixing a solid, powdered ammonium-, sulfur- and oxygen-containing-chemical additive; and
b. allowing decomposition of the solid powdered chemical additive to yield the gaseous catalyst.

5. The method of claim 4, wherein the ammonium-, sulfur- and oxygen-containing-chemical additives are selected from the group consisting of (NH₄)₂S₂O₈ (Ammonium persulfate), (NH₄)₂S₂O₇ (Ammonium pyrosulphate), (NH₄)₂SO₄ (ammonium sulfate), (NH₄)₂S₂O₃ (ammonium thiosulfate), (NH₄)₂SO₃ (ammonium Sulfite), NH₄HSO₃ (ammonium hydrogen sulfite), (NH4)₂S (ammonium sulfide).

6. The method of claim 1, wherein the sulfur-containing-catalyst is selected from the group consisting of HSO₄⁻-, HSO₃⁻, S₂O₇²⁻-, S₂O₈²⁻-, S₂O₃²⁻-, SO₃²⁻-containing compounds, SO₂, S and combinations thereof.

7. The method of claim 5, wherein the ammonium-, sulfur- and oxygen-containing chemical additives decompose into HSO₄⁻-, HSO₃⁻, S₂O₇²⁻-, S₂O₈²⁻-, S₂O₃²⁻-, SO₃²⁻-containing compounds, SO₂, S and combinations thereof.

8. The method of claim 4, wherein the step of heating the mixture in a flowing gas environment and holding for a period of time comprises two or more discrete sub-steps, wherein the heating temperature, gas environment and period of time is different for each discrete sub-step.

9. The method of claim 8, wherein the two or more discrete sub-steps comprises three discrete sub-steps of holding the mixture at the first temperature for a first period of time in a first gas environment; then holding the mixture at a second temperature for a second period of time in a second gas environment, and then holding the mixture at a third temperature for a third period of time in a third gas environment.

10. The method of claim 9 wherein any one or more of the first temperature, the second temperature or the third temperature coincide with any one or more of: a temperature of decomposition of the chemical additives, a temperature at which cross-linking of hydrocarbon materials occur, or a temperature at which reactions between the flowing gases and the hydrocarbon materials occur.

11. The method of claim 10, further comprising cooling the treated mixture to an end temperature.

12. The method of claim 11, wherein the end temperature is selected from room temperature and an intermediate temperature between room temperature and the third temperature.

13. The method of claim 1, wherein the treated hydrocarbon materials have an increased softening point temperature of between 100° C. to 350° C.

14. The method of claim 1 wherein the treated hydrocarbon materials having increased softening points are used as a feedstock to fabricate carbon fibers or activated carbons.

15. The method of claim 1 wherein the treated hydrocarbon materials having increased softening points are semi-solid or solid materials at room temperature without change of their chemical composition.

16. The method of claim 15, wherein the semi-solid or solid materials are further processable into solid physical forms including powders and pellets

17. The method of claim 16, wherein said pellets are re-heatable to a temperature suitable for extrusion or casting into various shapes and sizes.
